(19) United States
(12) Patent Application Publication
(10) Pub. No.: US 2024/0414730 A1
(43) Pub. Date: Dec. 12, 2024

(54) METHOD AND DEVICE FOR ARTIFICIAL INTELLIGENCE-BASED LOW-POWER COMMUNICATION OF UE IN WIRELESS COMMUNICATION SYSTEM

(71) Applicant: SAMSUNG ELECTRONICS CO., LTD., Suwon-si (KR)

(72) Inventors: Changsung LEE, Suwon-si (KR); Suhwook KIM, Suwon-si (KR); Jungsuk BAIK, Suwon-si (KR); Sooeun SONG, Suwon-si (KR); Jaehong YI, Suwon-si (KR); Hyeondeok JANG, Suwon-si (KR)

(21) Appl. No.: 18/741,668

(22) Filed: Jun. 12, 2024

(30) Foreign Application Priority Data
Jun. 12, 2023 (KR) 10-2023-0075132

(51) Int. Cl. H04W 72/231; H04W 24/02; H04W 52/02; H04W 76/28

(52) U.S. Cl. CPC H04W 72/231; H04W 24/02; H04W 52/0261; H04W 76/28

(57) ABSTRACT

The disclosure relates to an efficient method and device for AI-based low-power communication in a wireless communication system. According to an embodiment, a method for performing PDCCH monitoring by a UE in a wireless communication system comprises receiving, by the UE, from a base station, modification-related information about a first threshold previously set in the UE, as compared with output information about an artificial intelligence (AI) model trained to determine whether to perform the PDCCH monitoring and determining, by the UE, whether to perform the PDCCH monitoring by comparing the output information about the AI model with a second threshold adjusted by increasing or decreasing the first threshold to save power consumption in the UE, based on the modification-related information.

### CROSS-REFERENCE TO RELATED APPLICATION

This application is based on and claims priority under 35 U.S.C. § 119 to Korean Patent Application No. 10-2023-0075132, which was filed in the Korean Intellectual Property Office on Jun. 12, 2023, the entire disclosure of which is incorporated herein by reference.

### BACKGROUND

### 1. Field

The disclosure relates to a communication method and device for saving a user equipment (UE) power consumption in a wireless communication system.

### 2. Description of Related Art

Wireless communication technologies have been developed mainly for human services, such as voice, multimedia, and data communication. As 5th-generation (5G) communication systems are commercially available, connected devices are expected to explosively increase and to be connected to a communication network. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In the 6th-generation (6G) era, efforts are being made to develop an enhanced 6G communication system to provide various services by connecting hundreds of billions of devices and things. For this reason, the 6G communication system is called a beyond 5G system.

In the 6G communication system expected to be realized around year 2030, the maximum transmission rate is tera (i.e., 1000 gigabit) bps, and the wireless latency is 100 microseconds (usec). In other words, the transmission rate of the 6G communication system is 50 times faster than that of the 5G communication system, and the wireless latency is reduced to one tenth.

To achieve these high data rates and ultra low latency, 6G communication systems are considered to be implemented in terahertz bands (e.g., 95 gigahertz (95 GHz) to 3 terahertz (3 THz) bands). As the path loss and atmospheric absorption issues worsen in the terahertz band as compared with millimeter wave (mmWave) introduced in 5G, technology that may guarantee signal reach, that is, coverage, would become more important. As major techniques for ensuring coverage, there need to be developed multi-antenna transmission techniques, such as new waveform, beamforming, massive multiple-input and multiple-output (MIMO), full dimensional MIMO (FD-MIMO), array antennas, or large-scale antennas, which exhibit better coverage characteristics than radio frequency (RF) devices and orthogonal frequency division multiplexing (OFDM). New technologies, such as a metamaterial-based lens and antennas, high-dimensional spatial multiplexing technology using an orbital angular momentum (OAM), and a reconfigurable intelligent surface (RIS), are being discussed to enhance the coverage of the terahertz band signals.

For 6G communication systems to enhance frequency efficiency and system network for 6G communication systems include full-duplex technology, there are being developed full-duplex technology in which uplink and downlink simultaneously utilize the same frequency resource at the same time, network technology that comprehensively use satellite and high-altitude platform stations (HAPSs), network architecture innovation technology that enables optimization and automation of network operation and supports mobile base stations, dynamic spectrum sharing technology through collision avoidance based on prediction of spectrum usages, artificial intelligence (AI)-based communication technology that uses AI from the stage of designing and internalizes end-to-end AI supporting function to thereby optimize the system, and next-generation distributed computing technology that realizes services that exceed the limitation of the UE computation capability by ultra-high performance communication and mobile edge computing (MEC) or clouds. Further, continuous attempts have been made to reinforce connectivity between device, further optimizing the network, prompting implementation of network entities in software, and increase the openness of wireless communication by the design of a new protocol to be used in 6G communication systems, implementation of a hardware-based security environment, development of a mechanism for safely using data, and development of technology for maintaining privacy.

Such research and development efforts for 6G communication systems would implement the next hyper-connected experience via hyper-connectivity of 6G communication systems which encompass human-thing connections as well as thing-to-thing connections. Specifically, the 6G communication system would be able to provide services, such as truly immersive extended reality (XR), high-fidelity mobile hologram, and digital replica. Further, services, such as remote surgery, industrial automation and emergency response would be provided through the 6G communication system thanks to enhanced security and reliability and would have various applications in medical, auto, or home appliance industries.

### SUMMARY

The disclosure provides an efficient method and device for AI-based low power communication in a wireless communication system.

The disclosure also provides a method and device for adjusting a threshold for an AI-based PDCCH monitoring operation in a wireless communication system.

The disclosure also provides a method and device for setting/changing an operation mode for an AI-based PDCCH monitoring operation in a wireless communication system.

According to an embodiment, a method for performing PDCCH monitoring by a UE in a wireless communication system comprises receiving, by the UE, from a base station, modification-related information about a first threshold previously set in the UE, as compared with output information about an artificial intelligence (AI) model trained to determine whether to perform the PDCCH monitoring, and determining, by the UE, whether to perform the PDCCH monitoring by comparing the output information about the AI model with a second threshold adjusted by increasing or decreasing the first threshold to save power consumption in the UE, based on the modification-related information.

According to an embodiment, a UE performing PDCCH monitoring in a wireless communication system comprises a transceiver, and a processor configured to receive, by the UE, from a base station through the transceiver, modification-related information about a first threshold previously set in the UE, as compared with output information about an artificial intelligence (AI) model trained to determine whether to perform the PDCCH monitoring, and determine, by the UE, whether to perform the PDCCH monitoring by comparing the output information about the AI model with a second threshold adjusted by increasing or decreasing the first threshold to save power consumption in the UE, based on the modification-related information.

According to an embodiment, a method for performing PDCCH monitoring by a user equipment (UE) in a wireless communication system comprises receiving, from a base station, configuration information related to receiving a control signal indicating an operation mode to be applied in the UE among a plurality of operation modes for artificial intelligence (AI)-based PDCCH monitoring, receiving the control signal at a position of a resource configured to receive the control signal, based on the configuration information, and controlling a PDCCH monitoring operation by the indicated operation mode in a corresponding period, based on the control signal.

According to an embodiment, a UE performing PDCCH monitoring in a wireless communication system comprises a transceiver, and a processor configured to: receive, from a base station through the transceiver, configuration information related to receiving a control signal indicating an operation mode to be applied in the UE among a plurality of operation modes for artificial intelligence (AI)-based PDCCH monitoring, receive, through the transceiver, the control signal at a position of a resource configured to receive the control signal, based on the configuration information, and control a PDCCH monitoring operation by the indicated operation mode in a corresponding period, based on the control signal.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

A more complete appreciation of the disclosure and many of the attendant aspects thereof will be readily obtained as the same becomes better understood by reference to the following detailed description when considered in connection with the accompanying drawings, wherein:

FIG. 1 illustrates a basic structure of a time-frequency resource region in a 5G system according to an embodiment of the disclosure according to an embodiment of the present disclosure;

FIG. 2 illustrates an example of a slot structure in a 5G system according to an embodiment of the present disclosure;

FIG. 3 illustrates an example of a basic unit of time and frequency resource constituting a download control channel in 5G system according to an embodiment of the present disclosure;

FIG. 4 illustrates an example of a DRX operation in a 5G system according to an embodiment of the present disclosure;

FIG. 5 illustrates an AI-based PDCCH monitoring operation according to an embodiment of the present disclosure;

FIG. 6 illustrates an example of an AI model training method for an AI-based PDCCH monitoring operation according to an embodiment of the present disclosure;

FIG. 7 illustrates an example of sharing the same AI model by a UE and a base station according to an embodiment of the present disclosure;

FIG. 8 illustrates an example of a training method for reducing errors in an AI model according to an embodiment of the present disclosure;

FIG. 9 illustrates an example of determining whether to perform a PDCCH monitoring operation by comparing AI output information with a threshold from a trained AI model according to an embodiment of the present disclosure;

FIGS. 10, 11, and 12 illustrate an example of various methods for setting a threshold for an AI-based PDCCH monitoring operation according to embodiments of the present disclosure;

FIG. 13 illustrates a method for setting/changing an operation mode of AI-based PDCCH monitoring using an MMS according to an embodiment of the present disclosure;

FIG. 14 illustrates an offset applied upon MMS reception for setting an AI-based PDCCH monitoring operation according to an embodiment of the present disclosure;

FIG. 15 illustrates a method for setting/changing an operation mode for AI-based PDCCH monitoring according to an embodiment of the present disclosure;

FIG. 16 illustrates a method for a UE to determine an operation mode by receiving an MMS for AI-based PDCCH monitoring according to an embodiment of the present disclosure;

FIGS. 17 and 18 illustrates an AI-based PDCCH monitoring operation performed in parallel with a DRX operation according to embodiments of the present disclosure;

FIG. 19 illustrates a structure of a UE in a wireless communication system according to an embodiment of the present disclosure; and

FIG. 20 illustrates a structure of a base station in a wireless communication system according to an embodiment of the present disclosure.

### DETAILED DESCRIPTION

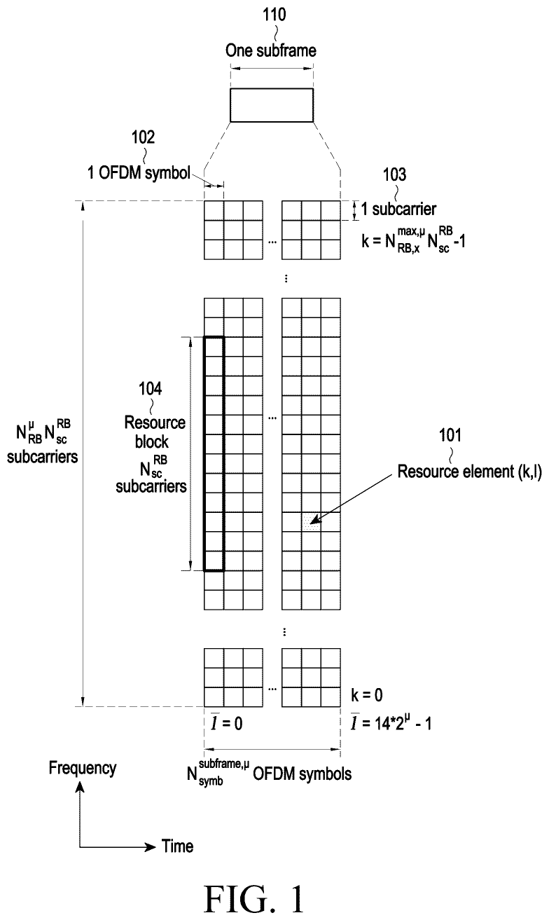

FIGS. 1 through 20, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure are described in detail with reference to the accompanying drawings. The same reference denotations may be used to refer to the same or similar elements throughout the specification and the drawings. When making the gist of the disclosure unclear, the detailed description of known functions or configurations is skipped.

In describing the embodiments of the disclosure, the description of technologies that are known in the art and are not directly related to the disclosure is omitted. This is for further clarifying the gist of the disclosure without making it unclear.

For the same reasons, some elements may be exaggerated or schematically shown. The size of each element does not necessarily reflect the real size of the element. The same reference numeral is used to refer to the same element throughout the drawings.

Advantages and features of the disclosure, and methods for achieving the same may be understood through the embodiments to be described below taken in conjunction with the accompanying drawings. However, the disclosure is not limited to the embodiments disclosed herein, and various changes may be made thereto. The embodiments disclosed herein are provided only to inform one of ordinary skilled in the art of the category of the disclosure. The disclosure is defined only by the appended claims. The same reference numeral denotes the same element throughout the specification.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit plays a certain role. However, ‘unit’ is not limited to software or hardware. A ‘unit’ may be configured in a storage medium that may be addressed or may be configured to execute one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the ‘units’ may be combined into smaller numbers of components and ‘units’ or further separated into additional components and “units.”. Further, the components and ‘units’ may be implemented to execute one or more CPUs in a device or secure multimedia card. According to embodiments, a “unit” may include one or more processors.

As used herein, each of such phrases as “A/B, “A or B”, “at least one of A and B”, “at least one of A or B”, “A, B, or C”, ““at least one of A, B, and C” and “at least one of A, B, or C” may include all possible combinations of the items enumerated together in a corresponding one of the phrases. As used herein, such terms as “1st” and “2nd” or “first” and “second” may be used to simply distinguish a corresponding component from another, and does not limit the components in other aspect (e.g., importance or order).

When determined to make the subject matter of the disclosure unnecessarily unclear, the detailed description of known functions or configurations may be skipped in describing embodiments of the disclosure. Hereinafter, the disclosure is described in detail with reference to the accompanying drawings.

As used herein, terms for identifying access nodes, terms denoting network entities, terms denoting messages, terms denoting inter-network entity interfaces, and terms denoting various pieces of identification information are provided as an example for ease of description. Thus, the disclosure is not limited to the terms, and the terms may be replaced with other terms denoting objects with equivalent technical meanings.

In the disclosure, the terms “physical channel” and “signal” may be used interchangeably with “data” or “control signal.” For example, physical downlink shared channel (PDSCH) denotes a physical channel where data is transmitted, but PDSCH may also be used to denote data. In other words, the expression “transmits a physical channel” in the disclosure may be equally interpreted as “transmits data or a signal through the physical channel.”

In the disclosure, higher signaling refers to a signal transfer method that transfers a signal from the base station to the UE using a physical layer downlink data channel or from the UE to the base station using a physical layer uplink data channel. Higher signaling may also be appreciated as radio resource control (RRC) signaling or media access control (MAC) control element (CE).

Further, although the disclosure describes various embodiments using terms used in some communication standards (e.g. 3rd generation partnership project (3GPP)), this is merely an example for description. Various embodiments of the disclosure may be easily modified and applied in other communication systems. The term UE may refer to mobile phones, smartphones, IoT devices, sensors, as well as other wireless communication devices.

Hereinafter, the base station may be an entity allocating resource to terminal and may be at least one of gNode B (gNB), eNode B (eNB), Node B, base station (BS), wireless access unit, base station controller, or node over network. The terminal may include UE (user equipment), MS (mobile station), cellular phone, smartphone, computer, or multimedia system capable of performing communication functions. Of course, it is not limited to the above examples. Although LTE, LTE-A, or NR based systems are described as examples in connection with embodiments of the disclosure, various embodiments of the disclosure may also apply to other communication systems with a similar technical background or channel form. Further, various embodiments of the disclosure may be modified in such a range as not to significantly depart from the scope of the disclosure under the determination by one of ordinary skill in the art and such modifications may be applicable to other communication systems.

In order to process recently soaring mobile data traffic, the initial standards of th 5th generation (5G) system or the new radio access technology (NR), which is the next-generation communication system after long term evolution (LTE) or evolved universal terrestrial radio access (E-UTRA) and LTE-advanced (LTE-A) or E-UTRA evolution, have been completed. While the conventional mobile communication system focuses on typical voice/data communication, the 5G system aims to meet various services and requirements, such as an enhanced mobile broadband (eMBB) service for enhancing conventional voice/data communication, an ultra-reliable and low latency communication (URLLC) service, and a massive machine type communication (MTC) service supporting a large amount of things communication.

While the legacy LTE and LTE-A system transmission bandwidth per single carrier is limited to up to 20 MHz, the 5G system mainly aims for high-speed data services ranging from several Gbps by utilizing a much wider ultra-wide bandwidth. Accordingly, 5G systems are considering ultra-high frequency bands ranging from several GHz to up to 100 GHz, in which it is relatively easy to secure ultra-wideband width frequencies, as candidate frequencies. Further, it is possible to secure a broadband frequency for a 5G system by relocating or allocating frequencies among frequency bands included in several GHz from hundreds of MHz used in legacy mobile communication systems.

Radio waves in the ultra-high frequency band have a wavelength of several mm and are sometimes called millimeter waves. However, in the ultra-high frequency band, the pathloss of radio waves increases in proportion to the frequency band, and the coverage of the mobile communication system decreases.

In order to overcome the disadvantage of coverage reduction in the ultra-high frequency band, a beamforming technology is applied to increase the arrival distance of radio waves by concentrating the radiation energy of radio waves to a predetermined target point using a plurality of antennas. In other words, in the signal to which the beamforming technology is applied, the beam width of the signal becomes relatively narrow, and radiation energy is concentrated within the narrowed beam width, thereby increasing the radio wave arrival distance. The beamforming technology may be applied to each of the transmission end and the reception end. In addition to the coverage increase effect, the beamforming technology has an effect of reducing interference in areas other than the beamforming direction. In order for the beamforming technology to operate properly, an accurate measurement and feedback method for the transmission/reception beam is required. The beamforming technology may be applied to a control channel or a data channel one-to-one corresponding between a predetermined UE and a base station. Further, beamforming technology for increasing coverage may also be applied to the control channel and data channel for transmitting the common signals transmitted to a plurality of UEs in the system by the base station, e.g., synchronization signal, physical broadcast channel (PBCH), and system information. When the beamforming technology is applied to the common signal, the beam sweeping technology that transmits the signal with the beam direction changed may be additionally applied so that the common signal may reach the UE present at an arbitrary position in the cell.

As another requirement of the 5G system, an ultra-low latency service with a transmission delay of about 1 ms between transmission and reception UEs is required. As one way to reduce transmission delay, it is necessary to design a short transmission time interval (TTI)-based frame structure that is shorter than LTE and LTE-A. The TTI is a basic time unit for performing scheduling, and the TTI of the legacy LTE and LTE-A systems is 1 ms corresponding to the length of one subframe. For example, as a short TTI for meeting the requirements for the ultra-low latency service of the 5G system, 0.5 ms, 0.25 ms, 0.125 ms, etc., which are shorter than legacy LTE and LTE—The systems, are possible.

In the disclosure, the higher layer signaling information may be signaling information corresponding to at least one or a combination of the following signaling information:
Master information block (MIB);
System information block (SIB) or SIB X (X=1, 2, . . . );
Radio resource control (RRC) information; and/or
Medium access control (MAC) control element (CE).

Further, L1 signaling information may be signaling information corresponding to at least one or a combination of one or more of the following physical layer channels or signaling methods using signaling”
Physical downlink control channel (PDCCH);
Downlink control information (DCI);
UE-specific DCI;
Group common DCI; and/or
Common DCI.

Further, in the following embodiments of the disclosure, the information transmitted and received by the higher layer signaling information between the base station and the UE may also be transmitted and received by various combinations of the higher layer signaling information and/or the L1 signaling information.

In the 5G system, a UE in a new state called RRC_INACTIVE has been defined to reduce energy and time consumed for initial access of the UE. The RRC_INACTIVE UE may perform the following operations in addition to the operations performed by the RRC_IDLE UE:
save access stratum (AS) information required for cell access;
UE-specific DRX operation set by RRC layer;
set up a radio access network (RAN)-based notification area (RNA) that may be utilized during handover by the RRC layer and perform periodic updates; and/or
RAN-based paging message monitoring operation transmitted through an active-radio network temporary identifier (I-RNTI).

The UE in the RRC_CONNECTED state may be changed from the RRC_CONNECTED state to the RRC_INACTIVE state or the RRC_IDLE state by receiving the RRC release indication from the base station.

The UE in the RRC_INACTIVE or RRC_IDLE state may perform random access to complete all random access procedures to change from RRC_INACTIVE or RRC_IDLE to RRC_CONNECTED.

FIG. 1 illustrates a basic structure of a time-frequency resource region in a 5G system according to an embodiment of the present disclosure.

Referring to FIG. 1, the horizontal axis refers to the time domain, and the vertical axis refers to the frequency domain. The minimum transmission unit in the time domain of the wireless communication system is an orthogonal frequency division multiplexing (OFDM) symbol, N^{slot}_{symb} symbols 102 may be gathered to form one slot 106, and N^{subframe}ₛₗₒₜ slots may be gathered to form one subframe 105. The length of the subframe is 1.0 ms, and 10 subframes may be gathered to form a 10 ms frame 114. In the frequency domain, the minimum transmission unit is subcarrier, and the bandwidth of the overall system transmission band may consist of a total of N_{BW} (104) subcarriers.

The basic resource unit in the time-frequency domain is resource element (RE) 112, and this may be represented with an OFDM symbol index and a subcarrier index. A resource block (RB) (or physical resource block (PRB) may be defined as N_{sc}^{RB} contiguous subcarriers 110 in the frequency domain. In the 5G system, N_{sc}^{RB}=12, and the data rate may increase in proportion to the number of RBs scheduled for the UE.

In a wireless communication system, a base station may map data on an RB basis and generally perform scheduling on the RBs that constitute one slot for a given UE. In other words, the basic time unit in which scheduling is performed in the 5G system may be a slot, and the basic frequency unit in which scheduling is performed may be an RB.

The number N^{slot}_{symb} of OFDM symbols is determined according to the length of the cyclic prefix (CP) added to each symbol to prevent interference between symbols. For example, when a normal CP is applied, N^{slot}_{symb}=14, and when an extended CP is applied N^{slot}_{symb}=12. The extended CP is applied to systems where the radio transmission distance is relatively longer than the normal CP, maintaining the orthogonality between symbols. In the case of the normal CP, the ratio between CP length and symbol length is maintained as a constant value, so that the overhead due to the CP may remain constant regardless of subcarrier spacing. In other words, when the subcarrier spacing decreases, the symbol length may increase, and the CP length may also increase accordingly. Conversely, when the subcarrier spacing increases, the symbol length may decrease, and thus the CP length may decrease. The symbol length and the CP length may be inversely proportional to the subcarrier spacing.

In a wireless communication system, various frame structures may be supported by adjusting subcarrier spacing to meet various services and requirements. For example, from the perspective of the operating frequency band, the larger the subcarrier spacing, the more advantageous it is to recovery of phase noise in a high frequency band. From a transmission time perspective, if the subcarrier spacing is large, the symbol length in the time domain is shortened, and as a result, the slot length is shortened, which is advantageous in supporting ultra-low delay services, such as URLLC. From a cell size perspective, the longer the CP length, the larger cells may be supported, so that the smaller the subcarrier spacing, the relatively larger cells may be supported. In mobile communications, cell is a concept that refers to an area covered by one base station.

Subcarrier spacing, CP length, etc. are essential information for OFDM transmission/reception, and seamless transmission/reception is possible only when the base station and UE recognize subcarrier spacing, CP length, etc. as common values.

Table 1 below illustrates the relationship between subcarrier spacing configuration (μ), subcarrier spacing (Δf), and CP length supported by the 5G system.

TABLE 1

| μ | Δf = 2^{μ} · 15[KHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

Table 2 below illustrates the number (N^{slot}_{symb}) of symbols per slot, the number (N^{frame,μ}ₛₗₒₜ) of slots per frame, and the number (N^{subframe,μ}ₛₗₒₜ) of slots per subframe, for each subcarrier spacing configuration (μ) in the case of the normal CP.

TABLE 2

| μ | N_{symb}^{slot} | Nₛₗₒₜ^{frame,μ} | Nₛₗₒₜ^{subframe,μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

At the early stage of introduction of the 5G system, coexistence or dual-mode operation with the legacy LTE and/or LTE-A (hereinafter, LTE/LTE-A) was expected. As a result, the legacy LTE/LTE-A may provide stable system operation to the UE, and the 5G system may provide enhanced services to the UE. Therefore, the frame structure of the 5G system needs to include at least the LTE/LTE-A frame structure or essential parameter set (e.g., subcarrier spacing=15 kHz).

When the frame structure of the 5G system is generalized, the subcarrier spacing, the CP length, the slot length, etc., which are essential parameter sets, are allowed to have an integer multiple relationship therebetween for each frame structure, thereby providing high scalability. A subframe having a fixed length of 1 ms may be defined to represent a reference time unit irrelevant to the frame structure.

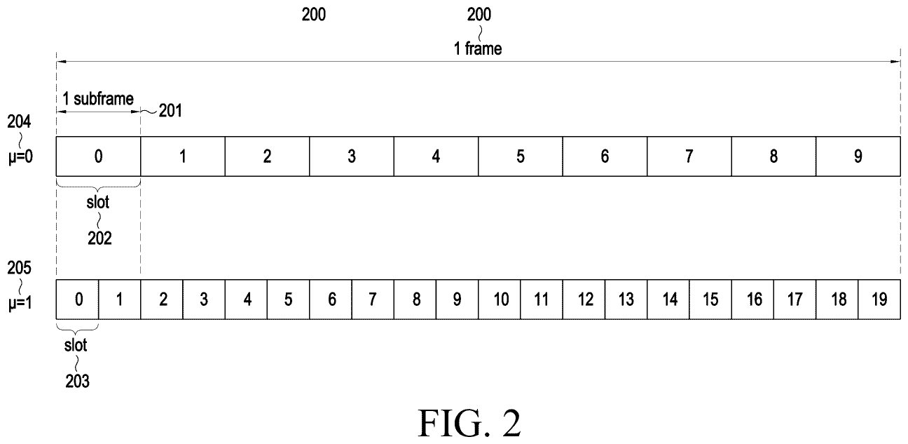

FIG. 2 illustrates an example of a slot structure in a 5G system according to an embodiment of the present disclosure.

FIG. 2 illustrates an example structure of a frame 200, a subframe 201, and a slot 202. One frame 200 may be defined as 10 ms. One subframe 201 may be defined as 1 ms, and one frame 200 may consist of a total of 10 subframes 201. One slot 202 or 203 may be defined as 14 OFDM symbols (that is, the number (N^{slot}_{symb}) of symbols per slot=14). One subframe 201 may be composed of one or more slots 202 and 203, and the number of slots 202 and 203 per subframe 201 may differ depending on μ (204 or 205), which is a set value for the subcarrier spacing. FIG. 2 illustrates an example in which the subcarrier spacing setting value μ=0 (204) and an example in which the subcarrier spacing setting value μ=1 (205). When μ=0 (204), one subframe 201 may consist of one slot 202, and when μ=1 (205), one subframe 201 may consist of two slots (203).

For example, when comparing a frame structure with a subcarrier spacing configuration μ=0 (frame structure A) and a frame structure with a subcarrier spacing configuration μ=1 (frame structure B), as compared to frame structure A, frame structure B has the subcarrier spacing and RB size increased in double, and the slot length and symbol length decreased in double. In the case of frame structure B, 2 slots may make up 1 subframe, and 20 subframes may make up 1 frame. The frame structure may be applied in response to various scenarios. From a cell size point of view, the longer the CP length, the larger cell may be supported, so that frame structure A may support a cell relatively larger than frame structure B. From an operating frequency band perspective, the larger the subcarrier spacing, the more advantageous it is to recover the phase noise in a high frequency band, so that frame structure B may support a relatively higher operating frequency than frame structure A. From a service point of view, a shorter length of the slot which is the basic time unit of scheduling may be more advantageous to support an ultra low latency service, such as URLLC, so that frame structure B may be appropriate for the URLLC service as compared with frame structure A.

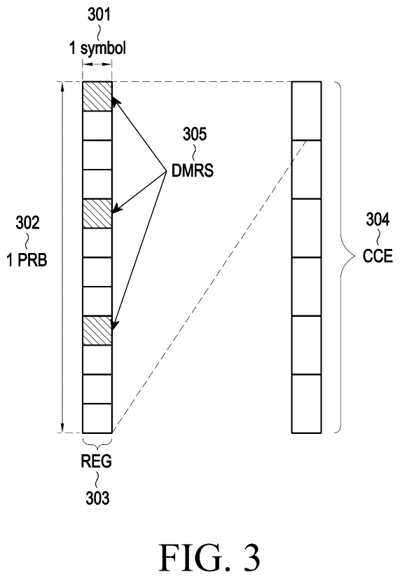

FIG. 3 illustrates an example of a basic unit of time and frequency resource constituting a download control channel in 5G system according to an embodiment of the present disclosure.

Referring to FIG. 3, the basic unit of time and frequency resources constituting the downlink control channel (PDCCH) may be referred to as a resource element group (REG) 303, and the REG 303 may be defined with one OFDM symbol 301 on the time axis and with one physical resource block (PRB) 302, i.e., 12 subcarriers, on the frequency axis. The base station may configure a downlink control channel allocation unit by concatenating REGs 303.

In 5G system, when the basic unit in which the downlink control channel is allocated is a control channel element (CCE) 304, one CCE 304 may be constituted of a plurality of REGs 303. For example, referring to FIG. 3, the REG 303 may be composed of 12 REs and, if one CCE 304 is composed of, e.g., 6 REGs 303, one CCE 304 may be composed of 72 REs. When the downlink control resource set is configured, the corresponding region may be constituted of a plurality of CCEs 304, and a specific downlink control channel may be mapped to one or more CCEs 304 according to the aggregation level (AL) in the control resource set and be transmitted. The CCEs 304 in the control resource set are distinguished with numbers, and in this case, the numbers of the CCEs 304 may be assigned according to a logical mapping scheme.

In FIG. 3, the REG 303 may include the REs to which the downlink control information (DCI) is mapped and the region where the DMRS 305 which is a reference signal for decoding the REs is mapped. As shown in FIG. 3, three DMRSs 305 may be transmitted in one REG 303. The number of CCEs necessary to transmit a PDCCH may be, e.g., 1, 2, 4, 8, or 16 depending on the aggregation level (AL), and different numbers of CCEs may be used to implement link adaptation of downlink control channel. For example, if AL=L, one downlink control channel may be transmitted via L CCEs. The UE needs to detect a signal while being unaware of information for downlink control channel and, for blind decoding, a search space is defined which indicates a set of CCEs. The search space is a set of candidate control channels constituted of CCEs that the UE attempts to decode on the given aggregation level, and since there are several aggregation levels to bundle up 1, 2, 4, 8, or 16 CCEs, the UE may have a plurality of search spaces. The search space set (Set) may be defined as a set of search spaces in all configured aggregation levels.

The DCI may be control information transmitted by the base station to the UE through the downlink. The DCI may include downlink data scheduling information or uplink data scheduling information for a predetermined UE. In general, the base station may independently perform channel coding for DCI for each UE and then transmit the DCI to each UE through the PDCCH, which is a downlink physical control channel. The base station may apply, to the UE to be scheduled, a DCI format determined according to the purpose such as whether it is scheduling information (downlink assignment) for downlink data, whether it is scheduling information (uplink grant) for uplink data, or whether it is DCI for power control. The base station may transmit downlink data to the UE through the PDSCH, which is a physical channel for downlink data transmission. The base station may inform the UE of scheduling information such as a specific mapping position in the time and frequency domain of the PDSCH, a modulation scheme, HARQ-related control information, and power control information through the DCI related to downlink data scheduling information among DCIs transmitted through the PDCCH.

The UE may transmit uplink data to the base station through a physical uplink shared channel (PUSCH), which is a physical channel for uplink data transmission. The base station may inform the UE of scheduling information such as a specific mapping position in the time and frequency domain of the PUSCH, modulation scheme, HARQ-related control information, power control information, etc. through the DCI related to uplink data scheduling information among DCIs transmitted through the PDCCH. The time-frequency resource to which the PDCCH is mapped may be referred to as a control resource set (CORESET). The CORESET may be configured in all or some frequency resources of a bandwidth supported by the UE in the frequency domain.

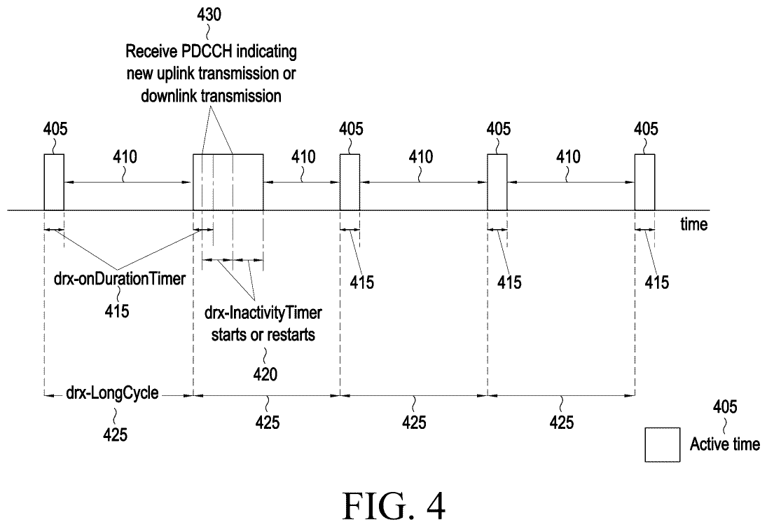

FIG. 4 illustrates an example of a discontinuous reception (DRX) operation in a 5G system according to an embodiment of the present disclosure.

Specifically, discontinuous reception (DRX) is an operation in which a UE using a service discontinuously receives data in an RRC connected state in which a radio link is established between a base station and the UE. DRX is also referred to as DRX in RRC connected state (i.e., C-DRX). When DRX is applied, the UE turns on the receiver at a specific time to monitor control channel, and if there is no data received for a certain period of time, turns off the receiver to reduce power consumption of the UE. The DRX operation may be controlled by the MAC layer device based on various parameters and timers.

Referring to FIG. 4, an active time 405 is a time during which the UE wakes up every DRX cycle and monitors PDCCH. The active time 405 may be defined as follows. The timers used in the DRX operation, such as drx-onDurationTimer 415, drx-InactivityTimer 420, drx-RetransmissionTimerDL, drx-RetransmissionTimerUL, and ra-ContentionResolutionTimer, are timers whose values are set by the base station, and have the function of configuring the UE to monitor PDCCH in the circumstance where a predetermined condition is met.

Further, the drx-onDurationTimer 415 is a parameter for setting a minimum time during which the UE is awake in the DRX cycle. The drx-InactivityTimer 420 is a parameter for setting an additional time during which the UE is awake when a PDCCH indicating new uplink transmission or downlink transmission is received (430). The drx-RetransmissionTimerDL is a parameter for setting a maximum time during which the UE is awake to receive downlink retransmission in the downlink HARQ procedure. The drx-RetransmissionTimerUL is a parameter for setting a maximum time during which the UE is awake to receive an uplink retransmission grant in the uplink HARQ procedure. The above-described drx-onDurationTimer, drx-InactivityTimer, drx-RetransmissionTimerDL and drx-RetransmissionTimerUL may be set as, e.g., time, number of subframes, number of slots, and the like. The ra-ContentionResolutionTimer is a parameter for monitoring PDCCH in the random access procedure.

The inActive time 410 is a time set to allow the UE not to monitor PDCCH during the DRX operation or a time set not to receive a PDCCH and may be the rest of the entire time during which DRX is performed, except for the active time 405. If the UE does not monitor PDCCH during the active time 405, the UE may enter a sleep or inactive state to reduce power consumption.

The DRX cycle means a cycle in which the UE wakes up and monitors PDCCH. In other words, the DRX cycle means a time interval from when the UE monitors a PDCCH to when the UE monitors a next PDCCH or an occurrence cycle of on-duration. There are two types of DRX cycles: short DRX cycle and long DRX cycle. The short DRX cycle may be applied optionally.

The long DRX cycle 425 is the longer of the two DRX cycles configured in the UE. The UE starts the drx-onDurationTimer 415 again, the long DRX cycle 425 after the start point (e.g., start symbol) of the drx-onDurationTimer 415 while operating in the long DRX. When operating in the long DRX cycle 425, the UE may start the drx-onDurationTimer 415 in a slot after drx-SlotOffset in a subframe meeting Equation 1 below. Here, the drx-SlotOffset means a delay before starting the drx-onDurationTimer 415. The drx-SlotOffset may be set to, e.g., time or number of slots, and the like as shown in Equation 1 below.

$$[ ( SFN \times 10 ) + subframe number ] modulo ( drx - LongCycle ) = drx - StartOffset . \qquad [ Equation 1 ]$$

Here, the drx-LongCycleStartOffset may include the long DRX cycle 425 and the drx-StartOffset, and may be used to define a subframe where the long DRX cycle 425 starts. The drx-LongCycleStartOffset may be set as, e.g., time, number of subframes, number of slots, and the like.

Previously proposed schemes in 3GPP for power consumption reduction in the UE are the same as the examples 1) to 3) below;
1) DRX scheme: A UE energy saving scheme in which as in the example of FIG. 4, the base station sets the DRX cycle on the UE to monitor the PDCCH periodically during the onDuration Timer in which the UE operates in the on state, and if the UE successfully receives DCI in the PDCCH, extends the active time through the Inactivity Timer;
2) Wake up signal (WUS) scheme: A scheme in which the UE first receives WUS (=DCP (DCI with cyclic redundancy check (CRC) scrambled by power saving radio network temporary identity (PS-RNTI)) before the onDuration, wakes up when the wake-up indication of the received WUS is 1 (it is in sleep state when the wake-up indication is 0), and obtains additional energy savings when there is no data to be transmitted to the UE; and/or
3) PDCCH skipping scheme: A scheme in which the base station instructs the UE to skip PDCCH monitoring for one or more consecutive slots to secure additional energy savings.

The above-described conventional power consumption saving schemes are ones provided to save the UE power consumption according to the instruction of the base station. In the above conventional methods, the UE performs PDCCH monitoring to perform PDCCH blind decoding in the search space every DRX cycle, by the instruction of the base station, or every slot in the active state. Further, since the DRX operation is a periodic operation, the UE may wait for scheduling until the next active cycle when downlink data for the UE arrives at the base station in the DRX sleep state, which leads to an increase in latency and a reduction in user perceived throughput (UPT). Further, since the DRX active/sleep state operates at an interval in the DRX operation, it is not possible to sleep perform micro-sleep targeting an exact slot in which the PDCCH is not transmitted, so power savings may not be efficiently performed. Further, the UE performs PDCCH monitoring, but if there is no DCI transmitted to the UE in the corresponding PDCCH, unnecessary power consumption occurs in the UE.

Embodiments of the disclosure, which is described below, provides methods for saving power consumption in the UE by dynamically/selectively performing monitoring of PDCCH by predicting the presence or absence of DCI transmitted to the UE on the PDCCH. To that end, in the embodiments of the disclosure, the UE may predict the presence or absence of DCI transmitted to the UE on the PDCCH using artificial intelligence (AI). Hereinafter, in the disclosure, an AI-based (AI-driven or AI-based) PDCCH monitoring operation by a UE is briefly referred to as an AI-based PDCCH monitoring operation.

In embodiments of the disclosure, prediction of the presence or absence of DCI transmitted to the UE may be performed based on a threshold. The threshold may also be referred to as a decision threshold for predicting the presence or absence of DCI. For example, if the AI output value associated with the PDCCH monitoring operation in the UE is larger than (or larger than or equal to) the threshold, the UE may perform the PDCCH monitoring operation for DCI reception by predicting that DCI transmitted to the UE is present. Further, if the AI output value associated with the PDCCH monitoring operation in the UE is less than (or less than or equal to) the threshold, the UE may not perform (or skip) the PDCCH monitoring operation for DCI reception by predicting that the DCI transmitted to the UE is not present.

In some embodiments of the disclosure, the threshold (or decision threshold) may be set/adjusted through negotiation (or signaling) between the UE and the base station. When the threshold is set to a relatively large value, the number of times of PDCCH monitoring for DCI reception in the UE is reduced, so the power saving effect (energy saving effect) in the UE is enhanced. Since the number of times of PDCCH monitoring for DCI reception in the UE increases when the threshold is set to a relatively small value, the power saving effect (energy saving effect) in the UE decreases. The UE and the base station may perform negotiation (or signaling) for adjusting the threshold considering the battery status, throughput, and the like of the UE.

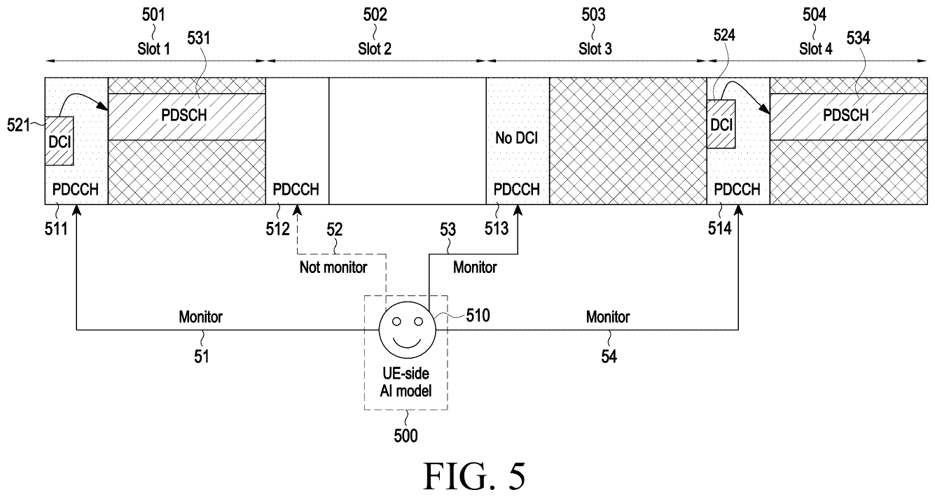

FIG. 5 illustrates an AI-based PDCCH monitoring operation according to an embodiment of the present disclosure.

FIG. 5 illustrates an example in which control resource sets are configured in a plurality of slots 501, 502, 503, and 504, and the DCI 521 and 524 for the UE 500 are transmitted in at least one of the PDCCHs 511, 512, 513, and 514 in the control resource sets. The DCI 521 and 524 may include scheduling information about the PDSCHs 531 and 534 through which downlink data scheduled for the UE 500 is transmitted. In the disclosure, the UE 500 may be set with a threshold for performing an AI-based PDCCH monitoring operation or adjust the set threshold through negotiation (signaling) with the base station.

In the disclosure, the UE 500 may obtain AI output information (e.g., AI output value) for identifying/determining whether to perform PDCCH monitoring ever slot, in units of predetermined resources, or according to a predetermined condition from the AI model 510 trained for AI-based PDCCH monitoring operation. For example, when the AI output value is larger than (or larger than or equal to) the threshold, the UE 500 may predict that the DCI 521 and 524 transmitted to the UE 500 are present and perform PDCCH monitoring operations 51 and 54 for DCI reception in the search space set in the control resource set in the corresponding slots 501 and 504. Further, if the AI output value is less or less than or equal to than the threshold, the UE 500 may predict that the DCI transmitted to the UE 500 is not present and may skip the PDCCH monitoring operation for DCI reception in the search space set in the control resource set within the slot 502.

In the case of a conventional UE that does not perform the AI-based PDCCH monitoring operation, the PDCCH monitoring operation may be performed according to the active state or DRX operation even when DCI transmitted to the UE is not present in the slot 503 as illustrated in reference numeral 53 of FIG. 5, which causes unnecessary power consumption in the UE.

In the disclosure, the presence or absence of DCI transmitted to the UE may be predicted using the AI model 510 trained based on channel information for the UE, scheduling history, and the like, and the AI-based PDCCH monitoring operation may be selectively performed by comparing the AI output value and the threshold according to the prediction. In this disclosure, the reliability of AI-based PDCCH monitoring operation may be enhanced by adjusting the threshold through negotiation signaling between the UE and the base station to compensate for the inaccuracy of prediction when only the AI model 510 is used, and as a result, power consumption caused by unnecessary PDCCH monitoring may be significantly reduced.

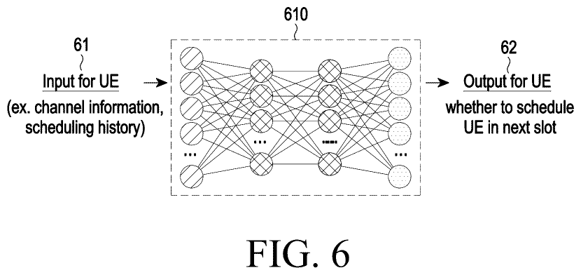

FIG. 6 illustrates an example of an AI model training method for an AI-based PDCCH monitoring operation according to an embodiment of the disclosure.

Referring to FIG. 6, the AI model 610 in the UE may output AI output information 62 by performing learning for the AI-based PDCCH monitoring operation based on the AI input information 61. The AI model 610 may use, for example, a deep learning (DL) algorithm of a neural network series such as a convolutional neural network (CNN) or a deep neural network (DNN), and an ML algorithm such as a support vector machine (SVM) or extreme gradient boosting (XGBoost). Further, the structure of the AI model 610 may use various AI models for addressing the classification issues among the AI/ML algorithms

In the AI model 610, DL or ML algorithm-based learning may be performed in the UE or the UE may receive the trained AI model 610 from the base station. When the base station provides the trained AI model 610 to the UE, the training of the AI model 610 may be performed by the base station. As an optional example, it may be possible to use optimized training data by performing training of the AI model 610 in each of the UE and the base station. Further, the UE and the base station share the same AI model 610, so that the base station may use the AI model 610 for scheduling for the UE, and the UE may use the AI model 610 for the AI-based PDCCH monitoring operation. When the UE and the base station share the same AI model 610, the scheduling-monitoring operations may be synchronized, thus preventing a situation in which the base station schedules the PDSCH for the UE but the UE does not perform PDCCH monitoring for DCI reception including scheduling information for the PDSCH.

Further, the above-described AI input information 61 may be collected for each UE, and for example, past scheduling history/statistics values may be used as channel-related information and/or scheduling history information for the UE, but the type and form of AI input information 61 are not limited thereto. The channel-related information may include, e.g., information that indirectly or directly reflects the possibility that the corresponding UE is scheduled in the current slot compared to other UEs. The scheduling history information may include information that indirectly or directly reflects whether there is traffic to be transmitted to the UE in the buffer in the base station in the current slot based on the traffic pattern arriving at the base station for transmission to the UE and the scheduling pattern according thereto.

The AI output information 62 may have a real number value between 0 and 1, e.g., for predicting (determining) whether the DCI may be transmitted to the UE in the next slot (whether to perform PDCCH monitoring). In an optional embodiment, the AI output information 62 may indicate a value for predicting (determining) whether to monitor PDCCH for the next n slots (where n is an integer larger than or equal to 1) at once. In the disclosure, the UE may determine whether to perform the PDCCH monitoring operation by comparing the threshold with the AI output information 62, and the threshold may be adjusted through signaling between the UE and the base station.

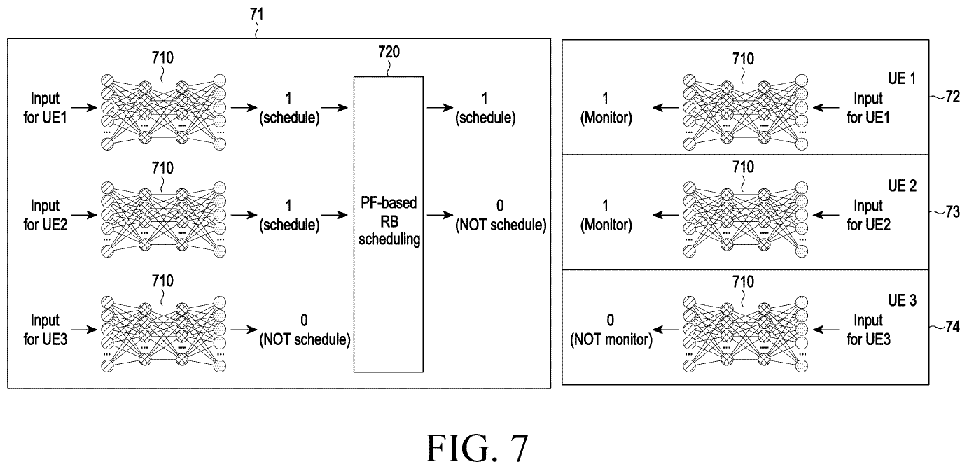

FIG. 7 illustrates an example of sharing the same AI model by a UE and a base station according to an embodiment of the present disclosure.

In the example of FIG. 7, the base station and the UE may share the same AI model 710. The AI model 710 may have AI input information and AI output information as in the example of FIG. 6 in the base station. The UE may receive the trained AI model 710 from the base station. In the example of FIG. 7, the base station may schedule downlink data to be transmitted to a plurality of UEs UE1, UE2, and UE3 using the AI model 710, and each of the UEs UE1, UE2, and UE3 may perform an AI-based PDCCH monitoring operation using the same AI model 710. For example, at reference numeral 71, when the AI model 710 of the base station outputs a positive value (“1”) for determining to schedule to UE1 based on input information for UE1, output a positive value (“1”) for determining to schedule to UE2 based on input information for UE2, and outputs a negative value (“0”) for determining not to schedule to UE3 based on input information for UE2, the scheduler 720 identifying output information (“1” or “0”) for each UE may schedule (“1”) resources for UE1 where no conflicts occur and may not schedule (“0”) resources for UE2 where a conflict occurs although not scheduled by the AI model 710, considering an occurrence of a conflict upon scheduling between the UEs UE1, UE2, and UE3.

Further, the scheduler 720 does not perform scheduling for UE3 for which scheduling is not determined in the AI model 710. On the other hand, reference numbers 72, 73, and 74, respectively, show an example of determining to perform PDCCH monitoring in the corresponding slot based on AI input information in UE1 using the same AI model 710 as the base station (“1”), an example of determining to perform PDCCH monitoring in the corresponding slot based on AI input information in UE2 using the AI model 710, and an example of determining not to perform PDCCH monitoring in the corresponding slot based on AI input information in UE3 using the AI model 710 (“0”). In the example of FIG. 7, since the base station and the UEs UE1, UE2, and UE3 use the same AI model 710, the same AI output information (value) may be obtained if there is no noise in the AI input information used by the base station and each UE. The base station may perform scheduling by setting only the UE whose AI output information is positive (“1”) as a scheduling candidate.

Further, in the example of FIG. 7, the base station and each UE may synchronize the scheduling operation with the PDCCH monitoring operation, so if the base station performs scheduling, it may prevent the UE from not performing the PDCCH monitoring operation. In the example of FIG. 7, the scheduler 720 of the base station exemplifies a proportional fair (PF) scheduler for convenience, but the scheduler of the base station is not limited to the PF scheduler in the disclosure, and embodiments of the disclosure may be applied regardless of the type of scheduler. Further, even if the UE and the base station do not share the same AI model and the UE uses an AI model, the AI-based PDCCH monitoring operation according to the disclosure may be performed in the UE.

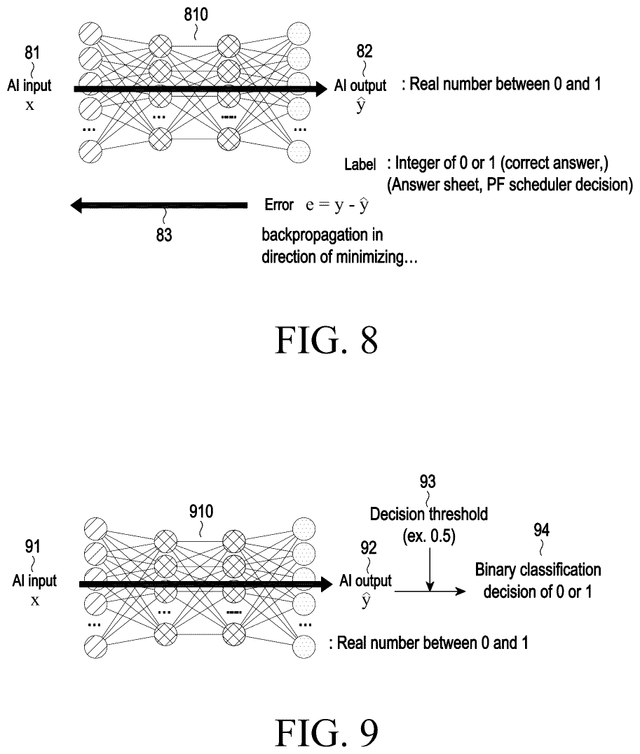

FIG. 8 illustrates an example of a training method for reducing errors in an AI model according to an embodiment of the present disclosure. FIG. 9 is a view illustrating an example of determining whether to perform a PDCCH monitoring operation by comparing AI output information with a threshold from a trained AI model according to an embodiment of the disclosure.

In FIG. 8, the AI model 810 may be trained based on supervised learning. The AI model 810 may output AI output information 82 based on the AI input information 81 in the same manner as in the example of FIG. 6. In FIG. 8, the label (correct answer) indicates, e.g., whether the scheduler (e.g., a PF scheduler) of the base station actually performs scheduling for the UE according to the AI input information 81, and the AI model 810 may be trained in a manner of performing backpropagation 83 to minimize errors. When the AI model 810 outputs the AI output information 82 according to the given AI input information 81 may be understood as a learning operation that imitates the operation (decision) of the scheduler. The UE may be led to perform PDCCH monitoring only when scheduling is determined using the trained AI model 810. AI model training as in the example of FIG. 8 may be performed by the base station, and the base station may provide the trained AI model to the UE. As an optional example, AI model training as in the example of FIG. 8 may be performed in each UE. As an optional example, AI model training as in the example of FIG. 8 is performed in each UE, and then the base station may receive the trained AI model from each UE to configure an integrated AI model.

In the example of FIG. 9, the AI model 910 may be trained as in the example of FIG. 8. The UE may determine whether to perform the PDCCH monitoring operation using the trained AI model 910. Specifically, as described in the example of FIG. 6, the UE may output a real number value between 0 and 1 as the AI output information 92 based on the AI input information 91. In the example of FIG. 9, the threshold 93 is assumed to be 0.5. The UE may compare the AI output information 92 (AI output value) with the threshold 93 and may predict that DCI transmitted to the UE is present when the AI output value 92 is larger than (or larger than or equal to) the threshold 93, and may perform a PDCCH monitoring operation for DCI reception in the corresponding slot. When the AI output value 92 is less than (or less than or equal to) the threshold 93, the UE may predict that the DCI transmitted to the UE is not present and skip the PDCCH monitoring operation for DCI reception in the corresponding slot. The processor in the UE may control whether to perform the PDCCH monitoring operation in such a manner as to output “1” when determining to perform the PDCCH monitoring operation and output “0” when determining to skip the PDCCH monitoring operation according to the result of comparison of the AI output value and the threshold.

Further, embodiments of this disclosure suggest various methods to adjust the threshold compared to the AI output value to further enhance the power saving effect in the UE's AI-based PDCCH monitoring operation or to reduce latency along with power savings. As the threshold increases, the UE performs PDCCH monitoring with less frequency, saving power consumption in the UE, but a problem of throughput reduction (UPT reduction)/latency increase in the UE may also occur. As the threshold decreases, the UE frequently performs PDCCH monitoring, increasing power consumption in the UE, but reducing throughput/latency. Therefore, there is a trade-off relationship between power savings due to AI-based PDCCH monitoring operation in the UE and throughput increase/latency reduction in the UE, and it is necessary to adjust the threshold to an appropriate value considering the UE's battery status, service provided to the UE, and network conditions. To that end, embodiments of the disclosure provide various methods for adjusting the threshold through signaling between the UE and the base station.

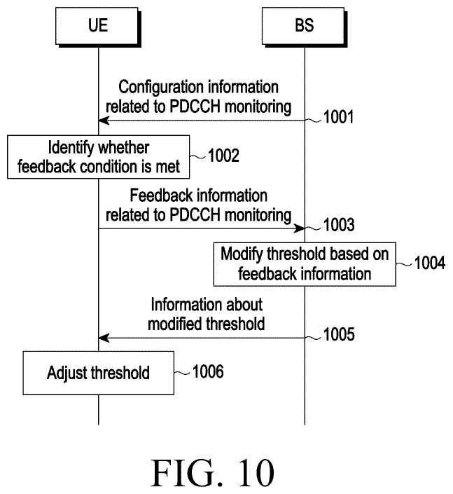

FIG. 10 illustrates an example of a method for setting a threshold for an AI-based PDCCH monitoring operation according to an embodiment of the present disclosure.

FIG. 10 shows an embodiment in which the UE identifies whether a feedback condition to transmit feedback information related to PDCCH monitoring to the base station BS is met, when the feedback condition is met, provides the feedback information related to PDCCH monitoring to the base station, and the base station modifies the threshold based on the feedback information and provides the modified threshold to the UE, and the UE adjusts the threshold based on the modified threshold.

Specifically, in step 1001 of FIG. 10, the UE receives configuration information related to PDCCH monitoring from the base station. The configuration information may be provided to the UE through the above-described higher layer signaling information. The base station may identify whether the UE subscribes to the ai-based PDCCH monitoring service through user data management (UDM), which manages subscription information in the core network, and policy control function (PCF), which manages policy information, and provide the above configuration information to the UE if the UE subscribes to the service.

The configuration information may include, e.g., an initial threshold that may be used during the AI-based PDCCH monitoring operation in the UE. The initial threshold may be set to a preset value/corrected value when the preset value is used or when the AI model is updated. Further, the configuration information may include information about a feedback condition for the UE to transmit feedback information related to PDCCH monitoring to the base station. The feedback condition may be set to a periodic time or may be set aperiodically according to a specific trigger condition. The trigger condition may be, e.g., a PDCCH monitoring failure ratio, packet delay, or the like. The PDCCH monitoring ratio may be defined as, e.g., Equation 2 below.

$$PDCCH monitoring failure ratio = 1 - \frac{number of DCI detections}{number of PDCC H monitoring attempts} . \qquad [ Equation 2 ]$$

The PDCCH monitoring failure ratio increases as the number of DCI detections in which the UE detects DCI in the PDCCH decreases compared to the number of PDCCH monitoring attempts by the UE. When the PDCCH monitoring failure ratio is larger than or equal to a predetermined ratio, the feedback condition in which the UE transmits feedback information for threshold adjustment may be met. The packet delay may be identified by packet delay measurement information obtained by the UE in the higher layer. When the packet delay is larger than or equal to a predetermined delay, the feedback condition in which the UE transmits feedback information may be met.

In step 1002 of FIG. 10, the UE may identify the PDCCH monitoring failure ratio, packet delay, and the like based on the configuration information to determine/identify whether the feedback condition for transmitting feedback information related to PDCCH monitoring from the UE to the base station is met. In the example of FIG. 10, it is assumed that the feedback condition is met. In step 1003, the UE transmits feedback information related to PDCCH monitoring to the base station. The feedback information may be transmitted to the base station through higher layer signaling. For example, the feedback information may include at least one of the PDCCH monitoring failure ratio and the packet delay measurement information measured in the UE.

In step 1004 of FIG. 10, the base station may correct the threshold set for the corresponding UE based on the feedback information received from the UE. At this time, the base station may modify the threshold set for the corresponding UE considering at least one of the key performance indicator (KPI) (e.g., UE IP throughput, cell throughput, etc.), quality of service (QoS), and base station policy which are network performance indicators, as well as the feedback information. In step 1005, the base station may provide information about the modified threshold such as RRC information or MAC CE to the UE through higher layer signaling. The information about the modified threshold may be provided, e.g., in the form of indicating a value that increases or decreases with respect to the existing threshold, or indicating the modified threshold itself.

Thereafter, in step 1006, the UE receiving the information about the modified threshold may adjust the previously set threshold to the modified threshold and apply the modified threshold as a threshold compared to AI output information (AI output value) of the AI model during AI-based PDCCH monitoring operation.

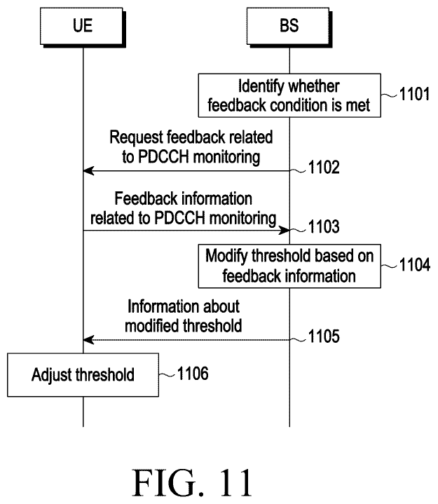

FIG. 11 is a view illustrating an example of a method for setting a threshold for an AI-based PDCCH monitoring operation according to an embodiment of the disclosure.

FIG. 11 shows an embodiment in which the base station BS identifies whether the feedback condition for receiving feedback information related to PDCCH monitoring from the UE is met, when the feedback condition is met, requests the UE to transmit feedback information related to PDCCH monitoring to the base station, the base station modifies the threshold based on the received feedback information and provides the threshold to the UE, and the UE adjusts the threshold based on the modified threshold. Since the base station determines whether the feedback condition is met in the example of FIG. 11, the provision of configuration information used to determine whether the UE meets the feedback condition may be omitted as in the embodiment of FIG. 10.

Specifically, in step 1101 of FIG. 11, the base station may determine/identify whether the feedback condition for receiving feedback information related to PDCCH monitoring from the UE is met by identifying packet delay for the UE performing the AI-based PDCCH monitoring operation. In the example of FIG. 11, the base station may determine/identify the packet delay through the difference between the packet arrival time and the departure time for the UE. The base station may determine/identify that the packet delay increases as the difference increases. When the measured packet delay is larger than or equal to a predetermined delay, the base station may determine that the feedback condition for receiving feedback information from the corresponding UE is met. In the example of FIG. 11, it is assumed that the feedback condition is met.

In step 1102, the base station may request the UE to transmit feedback information related to PDCCH monitoring. In an optional embodiment, the base station may omit step 1101 and transmit the request of step 1102 to the UE every predetermined period. In step 1103, the base station receives feedback information related to PDCCH monitoring from the UE. The feedback information may be transmitted from the UE to the base station through the above-described higher layer signaling. For example, the feedback information may include at least one of the PDCCH monitoring failure ratio and the packet delay measurement information measured in the UE.

In step 1104 of FIG. 11, the base station may correct the threshold set for the corresponding UE based on the feedback information received from the UE. At this time, the base station may modify the threshold set for the corresponding UE considering at least one of the KPI (e.g., UE IP throughput, cell throughput, etc.), quality of service (QOS), and base station policy which are network performance indicators, as well as the feedback information. In step 1105, the base station may provide information about the modified threshold such as RRC information or MAC CE to the UE through higher layer signaling. The information about the modified threshold may be provided, e.g., in the form of indicating a value that increases or decreases with respect to the existing threshold, or indicating the modified threshold itself.

Thereafter, in step 1106, the UE receiving the information about the modified threshold may adjust the previously set threshold to the modified threshold and apply the modified threshold as a threshold compared to AI output information (AI output value) of the AI model during AI-based PDCCH monitoring operation.

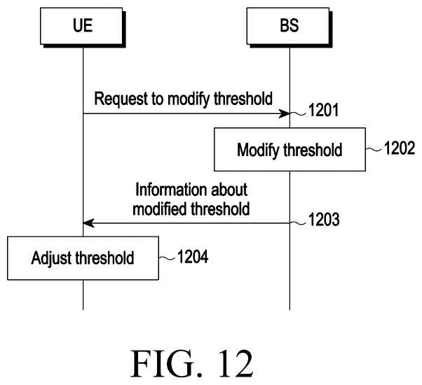

FIG. 12 illustrates an example of a method for setting a threshold for an AI-based PDCCH monitoring operation according to an embodiment of the present disclosure.

In the example of FIG. 12, the UE or the base station does not determine whether the feedback condition is met as in the example of FIG. 10 or 11, nor is transmission/reception of feedback information required. In the example of FIG. 12, if necessary, the UE requests the base station to modify the threshold related to PDCCH monitoring, and according to the request, the base station modifies and provides the threshold to the UE, and the UE may adjust the threshold based on the modified threshold.

Specifically, in step 1201 of FIG. 12, the UE performing the AI-based PDCCH monitoring operation may request the base station to modify the threshold related to PDCCH monitoring when a specific situation occurs in the UE, such as the UE's battery shortage or a sudden increase in packet delay while receiving a low-latency service. In step 1201, the request message may be transmitted through the above-described higher layer signaling. In an optional embodiment, the request message may include information indicating an increase or decrease in the threshold. For example, if the information is “1,” it may indicate a stepwise increase in the threshold, and if it is “0,” it may indicate a stepwise decrease in the threshold. In an optional embodiment, the request message may indicate to increase, decrease, or maintain the threshold by including 2-bit information.

In step 1202 of FIG. 12, the base station may modify the threshold set for the corresponding UE based on the information included in the request message. In an optional embodiment, the base station may modify the threshold set for the corresponding UE considering at least one of the KPI, QoS, and base station policy which are network performance indicators as well as information included in the request message. In step 1203, the base station may provide information about the modified threshold such as RRC information or MAC CE to the UE through higher layer signaling. The information about the modified threshold may be provided, e.g., in the form of indicating the value that increases or decreases with respect to the existing threshold, indicating the modified threshold itself, or indicating to maintain the existing threshold.

Thereafter, in step 1204, the UE receiving the information about the modified threshold may adjust the previously set threshold to the modified threshold and apply the modified threshold as a threshold compared to AI output information (AI output value) of the AI model during AI-based PDCCH monitoring operation.

According to the embodiments of FIGS. 10 to 12, it is possible to enhance power savings in the UE by adaptively/dynamically/periodically adjusting the threshold compared with the AI output information (AI output value) of the AI model when the UE performs the PDCCH monitoring operation according to the UE status or the network status and to properly control the UE's power saving operation considering an increase in throughput/decrease in latency in the UE.

The disclosure also provides embodiments for setting/changing the monitoring operation mode as may be performed in combination of the embodiments of AI-based PDCCH monitoring operation using the threshold. In the disclosure, the operation mode of the PDCCH monitoring operation may be set or changed using a monitoring mode signal (MMS) transmitted from the base station to the UE. The term ‘MMS’ is provided as an example, and it may be denoted by various terms indicating the operation mode of the PDCCH monitoring operation.

In an embodiment of the disclosure, operation modes that may be indicated through the MMS may be divided into, e.g., SMM, AMM, and NMM modes as shown in Table 3 below. For example, the above-described AMM may be applied when the data transmitted to the UE is delay-sensitive traffic or when the accuracy of the AI model is low, and the above-described NMM may be applied when there is no data to be transmitted to the UE in the buffer of the base station or when the base station performs a cell discontinuous transmission (DTX) operation. Examples of the SMM, AMM, and NMM are provided above, and the SMM, AMM, and NMM may be denoted by terms such as first to third operation modes for distinguishing between the operation modes.

Further, the MMS may include information (e.g., the N value) related to the period in which the indicated operation mode (SMM, AMM, or NMM) is applied. The information N related to the period may be set, e.g., to a predetermined number of slot units, subframe units, or frame units. N may be set to, e.g., 1, 2, 4, 8, . . . , and the period increases in proportion to the N value. The period corresponding to the N value may be preset. In an optional embodiment, the N value may be a multiple multiplied by the default period T₀ of the PDCCH monitoring operation, and the default period T₀ may be set, e.g., as a predetermined number of slot units, subframe units, or frame units. In this case, the period in which the indicated operation mode SMM, AMM, or NMM is applied may be set to N×T₀. In Table 3 below, the sleep state of the UE may be divided into a deep sleep state, a light sleep state, and a micro sleep state according to, e.g., the length of the duration of the sleep state of the UE. When the duration of the sleep state is larger than a first length (e.g., 20 ms), the sleep state may be divided as the deep sleep state, when the duration of the sleep state is less than or equal to the first length (e.g., 20 ms), and is larger than the second length (e.g., 6 ms), the sleep state may be divided as the light sleep state, and when the duration of the sleep state is less than or equal to the second length (e.g., 6 ms), the sleep state may be divided as the micro sleep state.

TABLE 3

| operation mode | description |
|---|---|
| SMM (Selective | when output information is positive (“1”) |
| monitoring mode) | according to the output information of the AI |
| | model for determining whether to perform |
| | PDCCH monitoring, the UE may operate in |
| | active state to perform PDCCH monitoring and, |
| | when the output information is negative (“0”), |
| | the UE does not perform PDCCH monitoring |
| | and may enter (micro) sleep state. |
| | In the SMM, the UE operates in active or (micro) |
| | sleep state to optionally perform PDCCH |
| | monitoring based on output information of AI |
| | model in corresponding period. |
| AMM (Always | In the AMM, the AI model of the UE does not |
| monitoring mode) | operate, and the UE operates in active state to |
| | perform PDCCH monitoring, e.g., every slot |
| | in the corresponding period. |
| NMM (No | In the NMM, the AI model of the UE does not |
| monitoring mode) | operate, and the UE does not perform PDCCH |
| | monitoring in the corresponding period. In this |
| | case, the UE may enter (deep or light) sleep state. |

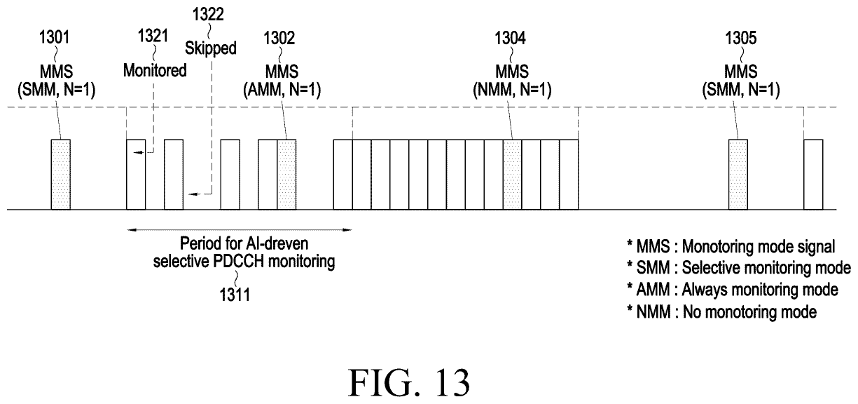

FIG. 13 illustrates a method for setting/changing an operation mode of AI-based PDCCH monitoring using an MMS according to an embodiment of the present disclosure. For convenience, the example of FIG. 13 assumes that the period of each operation mode indicated through the MMS is set equally as in the example of N=1. For example, the MMS may be received at least once each operation period.

Referring to FIG. 13, the UE may periodically receive the MMS indicating the operation mode of AI-based PDCCH monitoring from the base station. The operation mode according to the MMS received by the UE in the previous period may be applied to the AI-based PDCCH monitoring operation in the next period. For example, when the UE receives the MMS 1301 in a first period and the MMS 1301 indicates the SMM among the operation modes in Table 3, the UE performs an AI-based PDCCH monitoring operation according to the SMM in a second period 1311. In the example of FIG. 13, when the output information about the AI model for determining whether to selectively perform PDCCH monitoring in each slot of the second period 1311 is positive (“1”), the UE operates in an active state performing PDCCH monitoring (1321), and when the output information is negative (“0”), the UE may be in a (micro) sleep state not performing (or skipping) PDCCH monitoring (1322).

Further, when the UE receives the MMS 1302 in the second period 1311 and the MMS 1302 indicates the AMM among the operation modes in Table 3, the UE may perform a PDCCH monitoring operation every slot, e.g., according to the AMM which is the operation mode in the third period. In this case, the AI model of the UE does not operate in the third period. Further, when the UE receives the MMS 1304 in the third period and the MMS 1304 indicates the NMM among the operation modes in Table 3, the UE may not perform PDCCH monitoring according to the NMM which is the operation mode in the fourth period. In this case, the AI model of the UE does not operate in the fourth period. Further, when the UE receives the MMS 1305 in the fourth period and the MMS 1305 instructs the SMM among the operation modes in Table 3, the UE may optionally perform AI-based PDCCH monitoring as described above in the fifth period, which is not shown.

As in the example of FIG. 13, if the operation mode for AI-based PDCCH monitoring is adaptively set/changed through the MMS, power consumption of the UE generated by PDCCH monitoring may be more efficiently reduced.

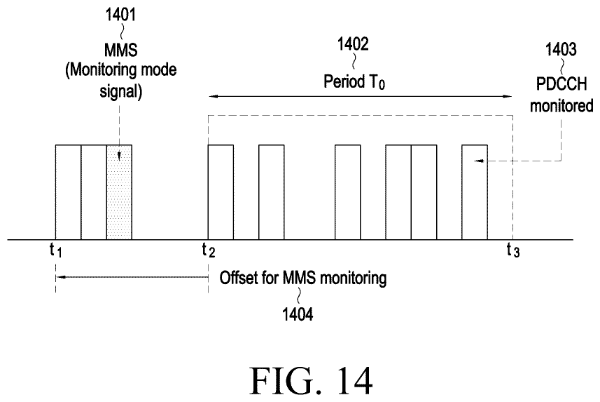

FIG. 14 illustrates an offset applied upon MMS reception for setting an AI-based PDCCH monitoring operation according to an embodiment of the present disclosure.

The UE may receive the MMS 1401 indicating the operation mode applied in the second period 1402 in the first period, which is a period before the second period 1402. For example, in the first period, the slot position at which the UE starts MMS monitoring for reception of the MMS 1401 may be set to a slot position t₁ in the first period, which is away by the offset 1404 from the start point t₂ of the second period 1402. In the example of FIG. 14, a margin may be placed between the slot position t₁ starting MMS monitoring and the slot position at which the MMS 1401 is received to allow the UE to stably receive the MMS. In FIG. 14, two slots are illustrated as the margin. In an optional embodiment, the slot position t₁ at which MMS monitoring starts may be set to be the same as the slot position at which the MMS 1401 is received. When the operation mode indicated through the MMS 1401 is the SMM described above, the UE may optionally perform AI-based PDCCH monitoring (1403). The offset 1404 may be provided in advance to the UE through configuration information or may use a predetermined offset.

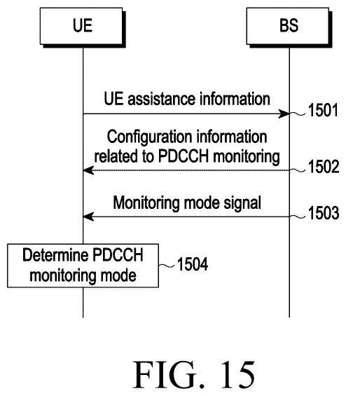

FIG. 15 illustrates a method for setting/changing an operation mode for AI-based PDCCH monitoring according to an embodiment of the disclosure.

In step 1501 of FIG. 15, the UE may transmit UE assistance information including UE capability (UE capability, etc.) or UE preference information related to AI-based PDCCH monitoring to the base station. For example, the UE capability information may include information indicating whether the corresponding UE supports AI-based PDCCH monitoring. The operation of step 1501 may be omitted. In step 1502, the UE may receive the configuration information related to AI-based PDCCH monitoring from the base station. The configuration information may include, e.g., at least one of information illustrated in Table 4 below.

TABLE 4

| | |
|---|---|
| Starting point of period | indicates the system frame number (SFN) |
| | where the MMS period starts and the slot |
| | number. Here, the MMS period means a period |
| | where the SMM, AMM, or NMM applies. |
| Period (To) | AI operation period controlled by one MMS |
| Offset for MMS | An offset to the time when the UE starts |
| monitoring | monitoring for MMS reception. The UE may |
| | specify the monitoring period for receiving |
| | MMS. |
| Handling MMS failure | indicates whether the UE operates in operation |
| | mode of SMM or AMM when failing to |
| | receive MMS. |
| Feedback for MMS | indicates whether the UE is to transmit |
| failure | feedback indicating failure in MMS reception |
| | to the base station when failing to receive |
| | MMS. The feedback is not transmitted when |
| | the UE succeeds in MMS reception. |
| UE bitmap | indicates the bitmap position of the |
| | corresponding UE when each UE uses a |
| | different operation mode. |
| UE class information | indicates the UE class where the UE belongs. |
| | UEs supporting AI-based PDCCH monitoring |
| | may be divided into multiple UE classes based |
| | on UE capability or UE preference transmitted |
| | as UE assistance information. |

The UE receiving the configuration information as in the example of Table 4 above may receive the MMS as a control signal transmitted by the base station at a set (resource) position in step 1503 of FIG. 15. Thereafter, in step 1504, the UE may determine the operation mode of the UE based on the operation mode (SMM, AMM, or NMM) indicated in the MMS, optionally perform AI-based PDCCH monitoring in slots within the corresponding period, or perform PDCCH monitoring in each slot within the corresponding period, or may not perform PDCCH monitoring in the corresponding period.

In the embodiment of the disclosure, the MMS may be configured and transmitted using at least one of the following methods 1 to 4.
Method 1: Method 1 may individually set an operation mode for each UE. In an optional embodiment, among a plurality of UEs using the AI model according to the disclosure, UE(s) having data to be transmitted from the base station become candidate UEs, and the base station may transmit an MMS for indicating the operation mode of SMM or AMM to the candidate UEs. In method 1, the MMS may include 2-bit information indicating SMM, AMM, or NMM as the operation mode. In method 1, the MMS may also include the N value indicating the operation mode change interval. The N value is an integer value, e.g., 1, 2, 4, 8, . . . . In method 1, the MMS is UE identification information introduced for AI-based PDCCH monitoring and may be scrambled by a new radio network temporary identifier (RNTI) and transmitted. In this case, only a UE that uses the new RNTI, i.e., supports AI-based PDCCH monitoring, may receive the MMS. In method 1, the MMS may be exemplified as shown in Table 5 below in the form of including 2-bit information indicating the operation mode and 2-bit information indicating the N value. Table 5 shows an example of indicating the operation modes of SMM, AMM, and NMM as “11,” “10,” and “01,” respectively, regardless of the UE class, and indicating 1, 2, 4, and 8 as “00,” “01,” “10,” and “11,” respectively, as the length of the period corresponding to the above N value.

TABLE 5

| | Mode | | Periods | |
|---|---|---|---|---|
| Al-capable UE1 | 1 | 1 | 0 | 0 |
| Al-capable UE2 | 0 | 1 | 1 | 0 |
| Al-capable UE3 | 1 | 0 | 0 | 1 |

Method 2: The MMS is configured in the same manner as the above method 1, but a different operation mode may be indicated for each UE class. For example, a plurality of classes may be divided according to the UE capability or UE preference. Table 6 below shows an example of indicating the operation modes of SMM, AMM, and NMM as “11,” “10,” and “01,” respectively, for three UE classes and indicating 1, 2, 4, and 8 as “00,” “01,” “10,” and “11,” respectively, as the length of the period corresponding to the above N value, according to method 2.

TABLE 6

| | Mode | | Periods | |
|---|---|---|---|---|
| Al-capable UE class 1 | 1 | 1 | 0 | 0 |
| Al-capable UE class 2 | 0 | 1 | 1 | 0 |
| Al-capable UE class 3 | 1 | 0 | 0 | 1 |

Method 3: Method 3 is a method of indicating the same operation mode to all UEs supporting AI-based PDCCH monitoring. In method 3, when there is data to be transmitted, the base station may indicate the operation mode of the SMM to all the UEs. When there is no data to be transmitted, the base station may operate in DTX. In method 3, the MMS may include 1-bit information indicating the SMM or NMM as the operation mode. For example, the 1-bit information may indicate operation modes of SMM and NMM as “1” and “0,” respectively. In method 3, the MMS may also include the N value indicating the operation mode change interval. The N value is an integer value, e.g., 1, 2, 4, 8, . . . . In method 3, the MMS may be scrambled by the new RNTI and transmitted as UE identification information introduced for AI-based PDCCH monitoring. The new RNTI may be allocated only to UEs supporting AI-based PDCCH monitoring. The MMS according to method 3 may be exemplified by the form shown in Table 7 below.

TABLE 7

| | Mode | Periods | |
|---|---|---|---|
| Al-capable UEs | 1 | 0 | 1 |

Method 4: In method 4, the MMS may be transmitted to the UE using a method of transmitting a sequence-based pilot signal.

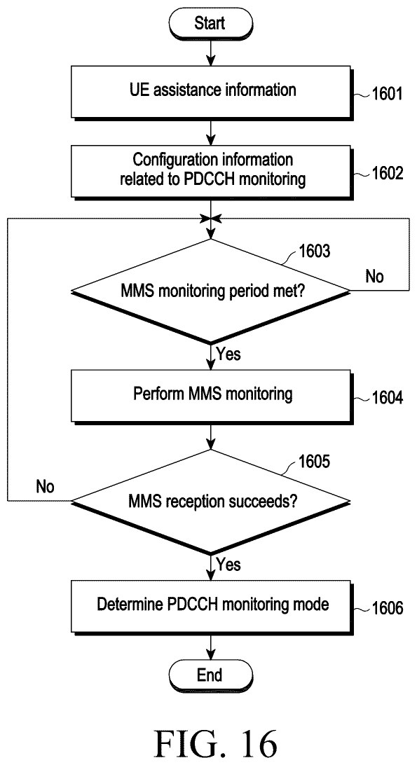

FIG. 16 illustrates a method for a UE to determine an operation mode by receiving an MMS for AI-based PDCCH monitoring according to an embodiment of the present disclosure.

In step 1601 of FIG. 16, the UE may transmit UE assistance information including UE capability information (UE class, etc.) related to AI-based PDCCH monitoring to the base station. For example, the UE capability information may include information indicating whether the corresponding UE supports AI-based PDCCH monitoring. The operation of step 1601 may be omitted. In step 1602, the UE may receive the configuration information related to AI-based PDCCH monitoring from the base station. The configuration information may include, e.g., at least one of the information exemplified in Table 4. In step 1603, the UE may identify an MMS monitoring period in which the corresponding UE may receive the MMS based on the offset information included in the configuration information. The identification of the MMS monitoring period using the offset information may be identified as in the example of FIG. 14. The UE identifying that the MMS monitoring period is met in step 1603 performs MMS monitoring in the corresponding period (e.g., slot period) in step 1604.

The UE, which fails to receive the MMS in step 1605, proceeds to step 1603 and repeats subsequent operations. In this case, the UE may perform MMS monitoring for indicating the operation mode to be applied in the next period. The UE succeeding in receiving the MMS in step 1605 may determine the operation mode of the UE based on the operation mode (SMM, AMM, or NMM) indicated by the MMS received in step 1606, selectively perform AI-based PDCCH monitoring in slots within the corresponding period, or perform PDCCH monitoring every slot within the corresponding period, or may not perform PDCCH monitoring in the corresponding period. In the example of FIG. 16, the UE succeeding in receiving the MMS may perform MMS monitoring in the first period in which the corresponding operation mode is applied. The MMS received according to the MMS monitoring in the first period indicates the operation mode to be applied in the next second period. Further, if the N value is larger than 1, the UE may not perform MMS monitoring for a period corresponding to N×T₀.

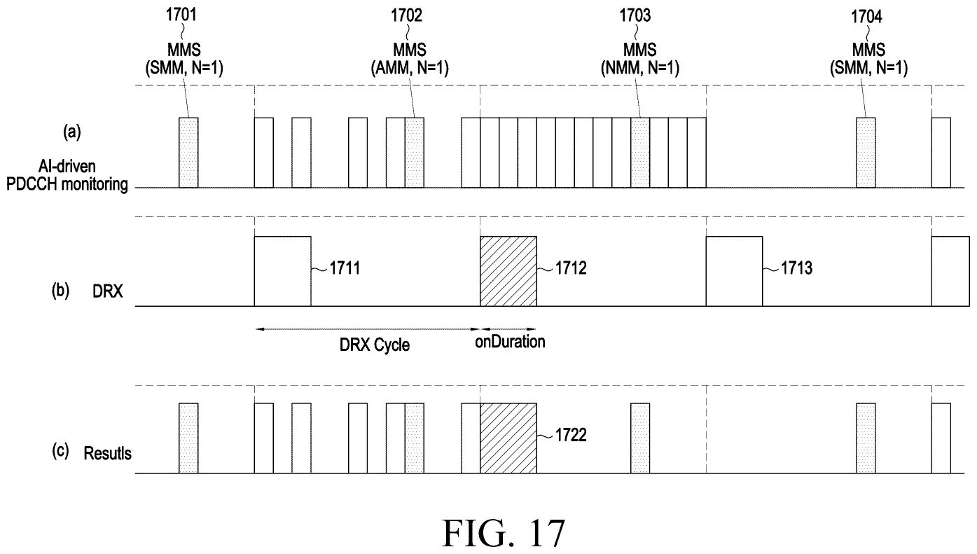

FIG. 17 illustrates an AI-based PDCCH monitoring operation performed in parallel with a DRX operation according to an embodiment of the present disclosure. The example of FIG. 17 illustrates a case in which an AI-based PDCCH monitoring operation is synchronized with a DRX operation. For convenience, the example of FIG. 17 assumes that the period of each operation mode indicated through the MMS is set equally as in the example of N=1. For example, the MMS may be received at least once each operation period.

In FIG. 17 (e.g., (a) of FIG. 17), the UE may periodically receive the MMS 1701, 1702, 1703, and 1704 indicating the operation mode of AI-based PDCCH monitoring from the base station. The operation mode according to the MMS received by the UE in the previous period may be applied to the AI-based PDCCH monitoring operation in the next period. Further, as shown in FIG. 17 (e.g., (b) of FIG. 17), if the DRX operation in which the UE wakes up in the on-duration periods 1711, 1712, and 1713 according to the DRX period to perform PDCCH monitoring is set in parallel with the AI-based PDCCH monitoring operation, the UE may apply the operation mode indicated by the MMS preferentially over the DRX operation in the periods of the SMM and the NMM among the operation modes indicated by the MMS. In this case, the UE may not perform the DRX operation and may perform the operation according to the operation mode indicated by the MMS in the onduration periods 1711 and 1713 as shown in FIG. 17 (e.g., (c) of FIG. 7) and, in the AMM period, may perform the DRX operation but not perform the operation according to the operation mode indicated by the MMS in the onduration period 1722 as shown in FIG. 17 (e.g., (c) of FIG. 7). As such, through the application of the DRX operation in the AMM period, additional energy saving effects may be obtained when there is no data to be transmitted to the UE or when the accuracy of the AI model is lowered.

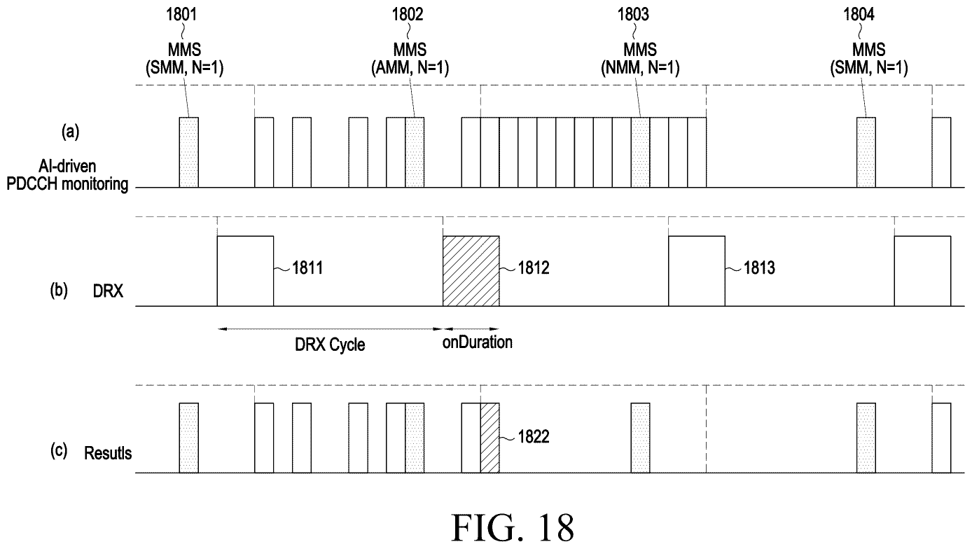

FIG. 18 illustrates an AI-based PDCCH monitoring operation performed in parallel with a DRX operation according to an embodiment of the present disclosure. The example of FIG. 18 illustrates a case in which an AI-based PDCCH monitoring operation is not synchronized with a DRX operation. For convenience, the example of FIG. 18 assumes that the period of each operation mode indicated through the MMS is set equally as in the example of N=1. For example, the MMS may be received at least once each operation period.

In FIG. 18 (e.g., (a) of FIG. 18), the UE may periodically receive the MMS 1801, 1802, 1803, and 1804 indicating the operation mode of AI-based PDCCH monitoring from the base station. The operation mode according to the MMS received by the UE in the previous period may be applied to the AI-based PDCCH monitoring operation in the next period. Further, as shown in FIG. 18(b), if the DRX operation in which the UE wakes up in the onduration periods 1811, 1812, and 1813 according to the DRX period to perform PDCCH monitoring is set in parallel with the AI-based PDCCH monitoring operation, the UE may apply the operation mode indicated by the MMS preferentially over the DRX operation in the periods of the SMM and the NMM among the operation modes indicated by the MMS. In this case, the UE may not perform the DRX operation and may operate according to the operation mode indicated by the MMS in the onduration periods 1811 and 1813 as shown in FIG. 18(c) and, in the AMM period, may perform the DRX operation but may not perform the operation according to the operation mode indicated by the MMS from the time of starting the period due to the MMS processing if the DRX onDurationTimer is operating at the time of starting the AMM period as shown in FIG. 18(c).

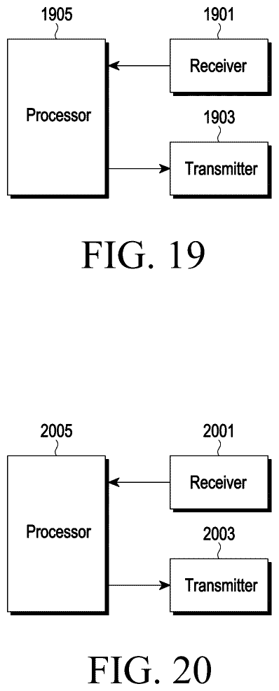

FIG. 19 illustrates a structure of a UE in a wireless communication system according to an embodiment of the present disclosure.

Referring to FIG. 19, a UE may include a transceiver that includes a receiver 1901 and a transmitter 1903, memory (not shown), and a processor 1905. The processor 1905 may be at least one processor and may be referred to as a controller or a control unit. The processor 1905 may control the overall device of the UE so that the UE may perform an AI-based PDCCH monitoring operation according to each of the above-described embodiments of the disclosure as well as a combination of at least an embodiment. However, the components of the UE are not limited thereto. For example, the UE may include more or fewer components than the above-described components. Further, the transceiver, memory, and processor may be implemented in the form of at least one chip.

The transceiver may transmit/receive signals to/from the base station. The signal may include control information and data. To that end, the transceiver may include a radio frequency (RF) transmitter for frequency-up converting and amplifying signals transmitted and an RF receiver for low-noise amplifying signals received and frequency-down converting the frequency of the received signals. However, this is merely an example of the transceiver, and the components of the transceiver are not limited to the RF transmitter and the RF receiver.

The transceiver may receive signals via a radio channel, output the signals to the processor 1905, and transmit signals output from the processor 1905 via a radio channel.

The memory may store programs and data necessary for the operation of the UE. The memory may store control information or data that is included in the signal transmitted/received by the UE. The memory may include a storage medium, such as ROM, RAM, hard disk, CD-ROM, and DVD, or a combination of storage media. There may be provided a plurality of memories.

Further, the processor 1905 may control a series of processes for the UE to be able to operate according to each or, a combination of at least one of, the above-described embodiments. There may be a plurality of processors 1905. The processor 1905 may perform control operations on the component(s) of the UE by executing a program stored in the memory.

FIG. 20 illustrates a structure of a base station in a wireless communication system according to an embodiment of the present disclosure.

Referring to FIG. 20, a base station may include a transceiver that includes a receiver 2001 and a transmitter 2003, memory (not shown), and a processor 2005. The base station may include a communication interface (not shown) for wired or wireless communication with another base station through a backhaul link. The processor 2005 may be at least one processor and may be referred to as a controller or a control unit. The processor 2005 may control the overall device of the base station to support an AI-based PDCCH monitoring operation in the UE according to each of the above-described embodiments of the disclosure as well as a combination of at least an embodiment. However, the components of the base station are not limited thereto. For example, the base station may include more or fewer components than the above-described components. Further, the transceiver, memory, and processor may be implemented in the form of at least one chip.

The transceiver may transmit/receive signals to/from the UE. The signal may include control information and data. To that end, the transceiver may include a radio frequency (RF) transmitter for frequency-up converting and amplifying signals transmitted and an RF receiver for low-noise amplifying signals received and frequency-down converting the frequency of the received signals. However, this is merely an example of the transceiver, and the components of the transceiver are not limited to the RF transmitter and the RF receiver.

The transceiver may receive signals via a radio channel, output the signals to the processor 2005, and transmit signals output from the processor 2005 via a radio channel.

The memory may store programs and data necessary for the operation of the base station. The memory may store control information or data that is included in the signal transmitted/received by the base station. The memory may include a storage medium, such as ROM, RAM, hard disk, CD-ROM, and DVD, or a combination of storage media. There may be provided a plurality of memories.

The processor 2005 may control a series of processes for the base station to operate according to the above-described embodiments. There may be a plurality of processors 2005. The processor 2005 may perform control operations on the component(s) of the base station by executing a program stored in the memory.

The methods according to the embodiments described in the specification or claims of the disclosure may be implemented in hardware, software, or a combination of hardware and software.

When implemented in software, there may be provided a computer readable storage medium storing one or more programs (software modules). One or more programs stored in the computer readable storage medium are configured to be executed by one or more processors in an electronic device. One or more programs include instructions that enable the electronic device to execute methods according to the embodiments described in the specification or claims of the disclosure.

The programs (software modules or software) may be stored in random access memories, non-volatile memories including flash memories, read-only memories (ROMs), electrically erasable programmable read-only memories (EEPROMs), magnetic disc storage devices, compact-disc ROMs, digital versatile discs (DVDs), or other types of optical storage devices, or magnetic cassettes. Or the programs may be stored in memory constituted of a combination of all or some thereof. As each constituting memory, multiple ones may be included.

The programs may be stored in attachable storage devices that may be accessed via a communication network, such as the Internet, Intranet, local area network (LAN), wide area network (WLAN), or storage area network (SAN) or a communication network configured of a combination thereof. The storage device may connect to the device that performs embodiments of the disclosure via an external port. A separate storage device over the communication network may be connected to the device that performs embodiments of the disclosure.

In the above-described specific embodiments, the components included in the disclosure are represented in singular or plural forms depending on specific embodiments provided. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

In the drawings illustrating methods according to embodiments, the order of description is not necessarily identical to the order of execution, and some operations may be performed in a different order or simultaneously.

Some of the components shown in the drawings illustrating methods of the disclosure may be omitted in such an extent as not to impair the gist or essence of the disclosure.

The methods in the disclosure may be performed in a combination of all or some of the embodiments described herein in such an extent as not to impair the gist or essence of the disclosure.

Various embodiments of the disclosure have been described above. The foregoing description of the disclosure is merely an example, and embodiments of the disclosure are not limited thereto. It will be appreciated by one of ordinary skill in the art that the disclosure may be implemented in other various specific forms without changing the essence or technical spirit of the disclosure. It should be noted that the scope of the disclosure is defined by the appended claims rather than the described description of the embodiments and include all modifications or changes made to the claims or equivalents of the claims.

What is claimed is:

1. A method of a user equipment (UE) for performing a physical downlink control channel (PDCCH) monitoring operation in a wireless communication system, the method comprising:
receiving, from a base station, modification-related information for a first threshold previously set in the UE, as compared with output information for an artificial intelligence (AI) model trained to determine whether to perform the PDCCH monitoring operation; and
determining, based on the modification-related information, whether to perform the PDCCH monitoring operation by comparing the output information for the AI model with a second threshold adjusted by increasing or decreasing the first threshold to save power consumption in the UE.

2. The method of claim 1, further comprising:
receiving, from the base station, configuration information related to the PDCCH monitoring operation; and
transmitting, to the base station, feedback information related to the PDCCH monitoring operation based on the configuration information,
wherein the modification-related information is received from the base station based on the feedback information.

3. The method of claim 2, wherein transmitting the feedback information further includes:
identifying, based on the configuration information, at least one of a packet delay or a failure ratio of the PDCCH monitoring operation;
determining, based on a result of the identification, whether a feedback condition for transmitting, to the base station, the feedback information is met; and
transmitting, to the base station, the feedback information when the feedback condition is met.

4. The method of claim 1, further comprising:
receiving, from the base station, a feedback request related to the PDCCH monitoring operation; and
transmitting, to the base station, feedback information related to the PDCCH monitoring operation in response to receiving the feedback request,
wherein the modification-related information is received from the base station based on the feedback information.

5. The method of claim 1, further comprising requesting the base station to modify the first threshold in case that at least one of a battery shortage or a packet delay occurs in the UE,
wherein the modification-related information is received in response to requesting the base station to modify the first threshold.

6. A UE performing a physical downlink control channel (PDCCH) monitoring operation in a wireless communication system, the UE comprising:
a transceiver; and
a processor configured to:
receive, from a base station through the transceiver, modification-related information for a first threshold previously set in the UE, as compared with output information about an artificial intelligence (AI) model trained to determine whether to perform the PDCCH monitoring operation; and
determine, based on the modification-related information, whether to perform the PDCCH monitoring operation by comparing the output information for the AI model with a second threshold adjusted by increasing or decreasing the first threshold to save power consumption in the UE.

7. The UE of claim 6, wherein the processor is further configured to:
receive, from the base station through the transceiver, configuration information related to the PDCCH monitoring; and
transmit, to the base station through the transceiver, feedback information related to the PDCCH monitoring operation based on the configuration information,
wherein the modification-related information is received from the base station based on the feedback information.

8. The UE of claim 7, wherein the processor is further configured to:
identify, based on the configuration information, at least one of a packet delay or a failure ratio of the PDCCH monitoring operation;
determine, based on a result of the identification, whether a feedback condition for transmitting, to the base station, the feedback information is met; and
transmit, to the base station through the transceiver, the feedback information when the feedback condition is met.

9. The UE of claim 6, wherein the processor is further configured to:
receive, from the base station through the transceiver, a feedback request related to the PDCCH monitoring operation; and
transmit, to the base station through the transceiver, feedback information related to the PDCCH monitoring operation in response to receiving the feedback request,
wherein the modification-related information is received from the base station based on the feedback information.

10. The UE of claim 6, wherein the processor is further configured to request the base station to modify the first threshold, through the transceiver in case that at least one of a battery shortage or a packet delay occurs in the UE,
wherein the modification-related information is received in response to requesting the base station to modify the first threshold.

11. A method of a user equipment (UE) for performing a physical downlink control channel (PDCCH) monitoring operation in a wireless communication system, the method comprising:
receiving, from a base station, configuration information for receiving a control signal indicating an operation mode to be applied in the UE among a plurality of operation modes for an artificial intelligence (AI)-based PDCCH monitoring operation;
receiving, based on the configuration information, the control signal at a position of a resource configured to receive the control signal; and
performing, based on the control signal, the PDCCH monitoring operation by the indicated operation mode in a corresponding period.

12. The method of claim 11, wherein the plurality of operation modes includes at least one of:
a first operation mode in which the PDCCH monitoring operation is selectively performed based on output information for an AI model in the UE in the corresponding period;
a second operation mode in which the PDCCH monitoring operation is performed entire slots in the corresponding period; and
a third operation mode in which the PDCCH monitoring operation is omitted in the corresponding period.

13. The method of claim 11, wherein the position of the resource where the control signal is received is configured as a slot position in a first period that is an offset away from a start point of a second period where the indicated operation mode is applied.

14. The method of claim 11, further comprising performing a monitoring operation for receiving the control signal in a second period immediately before a first period where the indicated operation mode is applied.

15. The method of claim 11, wherein at least one of the plurality of operation modes is performed preferentially before a discontinuous reception (DRX) operation of the UE in case that the AI-based PDCCH monitoring operation is performed in parallel to the DRX operation.

16. A UE performing a physical downlink control channel (PDCCH) monitoring operation in a wireless communication system, the UE comprising:
a transceiver; and
a processor configured to:
receive, from a base station through the transceiver, configuration information related to receiving a control signal indicating an operation mode to be applied in the UE among a plurality of operation modes for artificial intelligence (AI)-based PDCCH monitoring;
receive, from the base station through the transceiver, the control signal at a position of a resource configured to receive the control signal based on the configuration information; and
perform, based on the control signal, a PDCCH monitoring operation by the indicated operation mode in a corresponding period.

17. The UE of claim 16, wherein the plurality of operation modes includes at least one of:
a first operation mode in which the PDCCH monitoring is selectively performed based on output information for an AI model in the UE in the corresponding period;
a second operation mode in which the PDCCH monitoring operation is performed entire slot in the corresponding period; and
a third operation mode in which the PDCCH monitoring operation is omitted in the corresponding period.

18. The UE of claim 16, wherein the position of the resource where the control signal is received is configured as a slot position in a first period that is an offset away from a start point of a second period where the indicated operation mode is applied.

19. The UE of claim 16, wherein the processor is further configured to perform a monitoring operation for receiving the control signal in a second period immediately before a first period where the indicated operation mode is applied.

20. The UE of claim 16, wherein at least one of the plurality of operation modes is performed preferentially before a discontinuous reception (DRX) operation of the UE in case that the AI-based PDCCH monitoring operation is performed in parallel to the DRX operation.
